(19) United States
(12) Patent Application Publication
(10) Pub. No.: US 2009/0109874 A1
(43) Pub. Date: Apr. 30, 2009

(54) IDENTIFYING NODES IN A NETWORK

(75) Inventor: Daniel Migault, Issy Les Moulineaux (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/298,791

(22) PCT Filed: Apr. 12, 2007
(86) PCT No.: PCT/FR2007/051097

§ 371 Date: Oct. 28, 2008

(30) Foreign Application Priority Data
Apr. 28, 2006 (FR) 0651527

(51) Int. Cl. H04L 12/28

(52) U.S. Cl. 370/254

(57) ABSTRACT

A method of secure mutual identification of nodes (Nₙ) in a communications network comprising for each node a file (Fₙ) containing parameters descriptive of the node, each parameter being indexed by a cryptographic identifier of the node and an identifier of the parameter. An interface (IR) broadcasts from the node a message containing the cryptographic identifier of said node to the other nodes of the network. A unit (UC) transmits an identification request containing the cryptographic identifier of a first other node and the identifier of a parameter of said first other node requested by said node. A unit (HF) searches the file for a part of a parameter requested by a second other node as a function of the cryptographic identifier of said node and the identifier of the parameter transmitted by the second other node, and the interface transmits the part found of the parameter requested by the second other node to said second other node.

The present invention relates to identifying nodes in a network.

It relates more particularly to secure identification of heterogeneous nodes in a network with no infrastructure, for example an ad hoc network. Identification in accordance with the invention is based on the Domain Name System conforming to the DNS/DNSSEC (Domain Name System/Domain Name System Security) specification to facilitate its subsequent integration.

A Domain Name System is specifically designed for a communications network including an infrastructure such as the Internet or an Intranet that connects to nodes such as terminals or servers. The naming system matches each of these nodes to one or more understandable names, known as domain names, for example “mydomain.com”, to network information relating to the node, such as text fields, cryptographic identifiers, security parameters, a mail server, or more particularly IP (Internet Protocol) addresses. These matches are stored in one or more databases connected to or integrated into one or more servers dedicated to the domain name service, known as DNS servers. All these services are accessible to a client node requesting access to a domain name in order to find the match between the domain name and the network node associated with said domain name.

At present networks, and especially networks with no infrastructure, such as ad hoc networks, use the network nodes to provide connectivity between users of said nodes. These nodes are very heterogeneous and can be simple entities such as servers or terminals or complex entities such as networks. The DNS does not apply to the complex entities.

Similarly, the DNS does not apply to nodes connected in a network with no infrastructure, such as an ad hoc network, in which calls are set up spontaneously between two nodes without the intermediary of a simple entity. The nodes of an ad hoc network are a priori unknown to each other and have no references in DNS servers.

The invention overcomes this shortcoming by identifying heterogeneous nodes as simple nodes and complex nodes present in a network with no infrastructure.

The invention relates to a method of identifying a node to other nodes in a communications network, characterized in that it comprises the following steps:
storing in each node a file containing descriptive parameters of the node, each parameter being indexed by a cryptographic identifier of the node and a parameter identifier;
a first node, on connecting to the network, broadcasting to the other nodes of the network the cryptographic identifier of said first node;
sending the cryptographic identifier of the first node and the identifier of a parameter of the first node requested by another node of the network from said other node to the first node;
searching for a portion of the requested parameter in the file of the first node as a function of the cryptographic identifier and the identifier of the requested parameter; and
sending the found portion of the requested parameter from the first node to said other node.

The invention advantageously identifies any type of node, both simple nodes such as servers, mobile terminals or computers and complex nodes such as networks, such nodes being unknown in the Domain Name System conforming to the DNS specification.

Identification based on a cryptographic identifier is universal for all nodes, because the cryptographic identifier of each node relates to a public key of a public key/private key pair assigned to the node.

According to one feature of the invention, the identifier of a descriptive parameter is a name dedicated to the parameter that distinguishes descriptive parameters from each other and thus enables the file to contain a large number of descriptive parameters.

According to another feature of the invention, the identifier of a descriptive parameter is a type characterizing the parameter, which facilitates subsequent integration of the invention into the DNS.

The invention also relates to a node of a communications network, characterized in that it comprises:
a memory for a file containing descriptive parameters of the node, each parameter being indexed by a cryptographic identifier of the node and a parameter identifier;
means for broadcasting the cryptographic identifier of said node to the other nodes of the network;
means for sending the cryptographic identifier of a first other node and the identifier of a parameter of said first other node requested by said node;
means for searching the file for a portion of a parameter requested by a second other node as a function of the cryptographic identifier of said node and the identifier of the parameter sent by the second other node; and
means for sending to said second other node the found portion of the parameter.

The invention finally relates to a computer program including instructions for executing the method of the invention when said instructions are executed by a processor in a node of the invention.

Other features and advantages of the present invention become more clearly apparent on reading the following description of embodiments of the invention, given by way of non-limiting example, with reference to the corresponding appended drawings, in which:

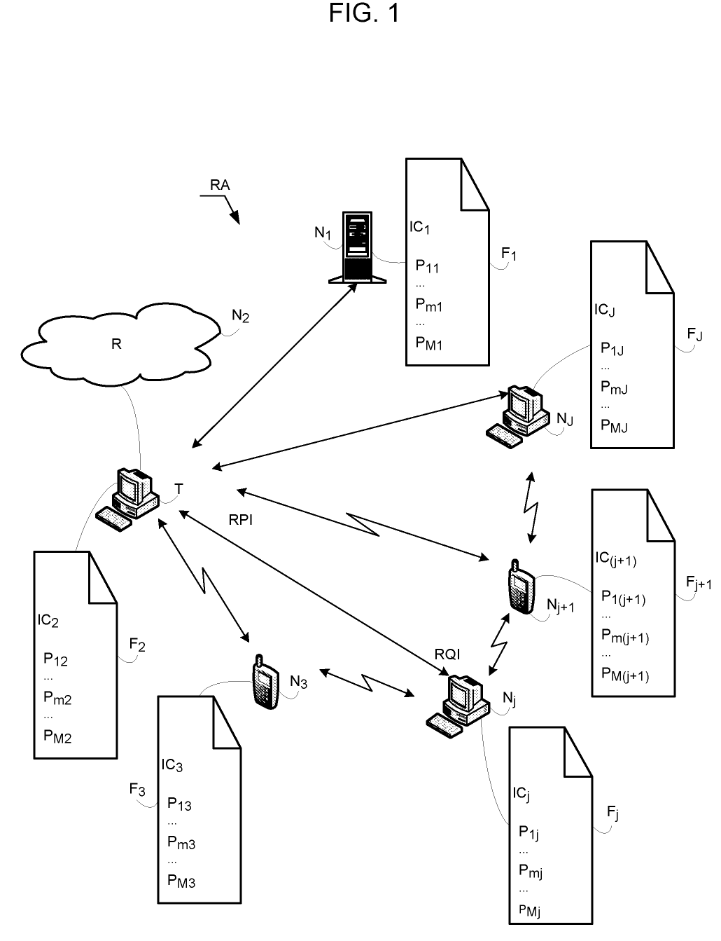

FIG. 1 is a block diagram of an identification system in a network of the invention with no infrastructure;

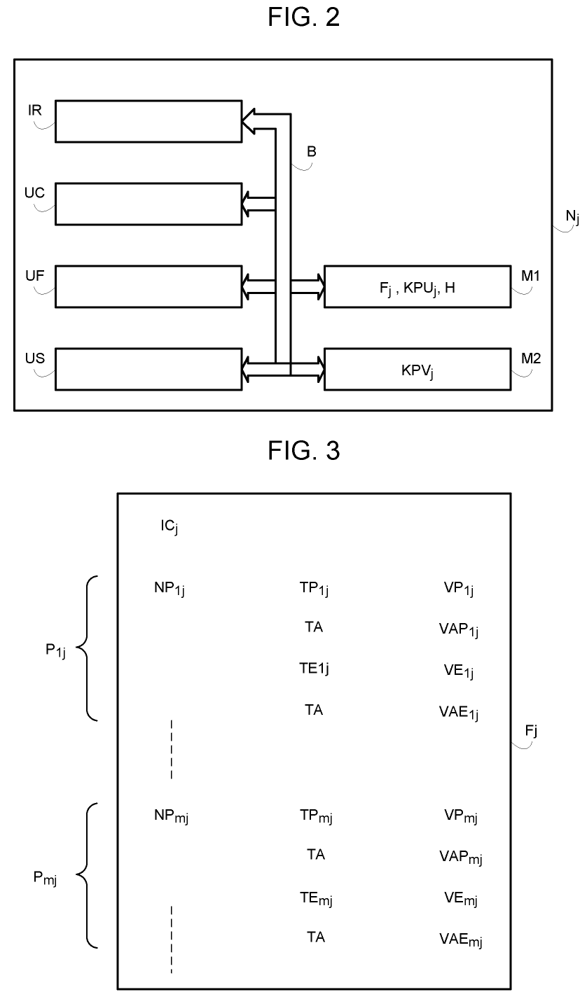

FIG. 2 is a block diagram of a node of the invention;

FIG. 3 is a diagram representing a node descriptor file of the invention;

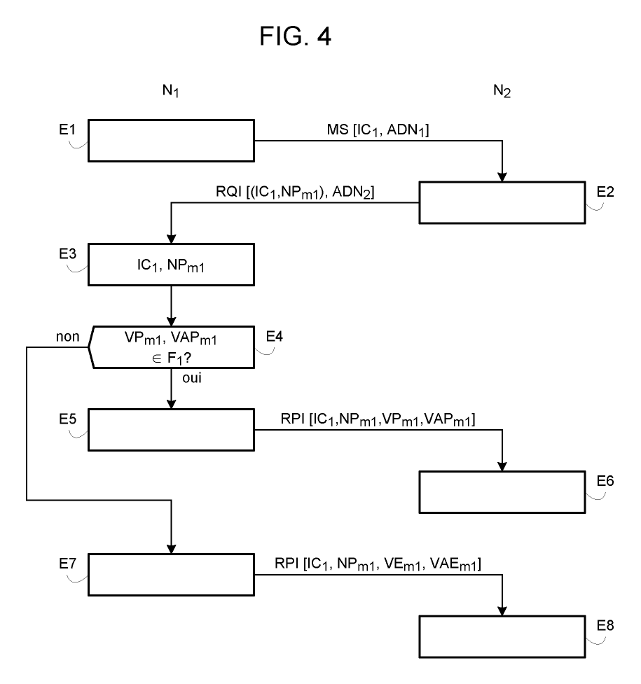

FIG. 4 shows an algorithm of a node identification method of the invention;

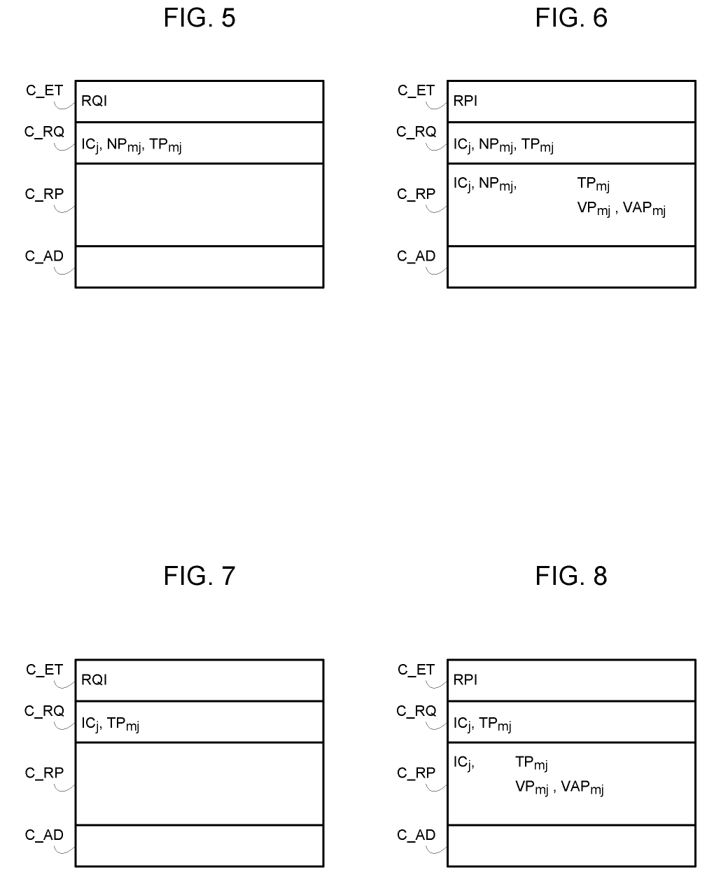

FIGS. 5 and 6 are diagrams respectively representing an identification request and an identification response in a first embodiment of the invention; and

FIGS. 7 and 8 are diagrams respectively representing an identification request and an identification response in a second embodiment of the invention.

Referring to FIG. 1, an identification system of the invention comprises heterogeneous nodes N₁ and N_{J} in a communications network with no infrastructure. The network is an ad hoc network RA, for example, and is referred to as such in the remainder of the description. In the ad hoc network RA, calls between nodes are set up spontaneously and the nodes have no prior knowledge of the other nodes in the network. According to the invention, mutual identification of two nodes is effected by exchanging an identification request RQI and an identification response RPI.

The nodes are heterogeneous and can be simple entities such as a server N₁, a mobile terminal N₃, Nⱼ₊₁, or a personal computer Nⱼ, N_{J} and/or complex entities such as a network R forming the node N₂ and associated with a terminal T. The network R is different from an ad hoc network and can be a network with an infrastructure, such as the Internet or an Intranet, to which client terminals are connected by wires or wirelessly, or a GSM (Global System for Mobile communications) or UMTS (Universal Mobile Telecommunications System) radio communications network.

In each node Nⱼ, where 1≦j≦J, the invention creates and stores a descriptive file Fⱼ including descriptive information specific to the node, such as information relating to the identity of the node, for example: if the node is a router or a terminal, information relating to the location of the node, for example an IP address, and accessible to the other nodes. Where the node N₂ is concerned, the terminal T associated with the network R includes the descriptive file F₂ identifying the network R.

The descriptive information specific to the node Nⱼ is referred to in the remainder of the description as the descriptive parameters Pₘⱼ, where 1≦m≦M, and where the integer M can be different from one node to another. The file Fⱼ of the node Nⱼ is described in more detail with reference to FIG. 3.

As shown in FIG. 2, the nodes N₁ to Nⱼ of the ad hoc network RA includes similar entities in order to implement the identification method of the invention described with reference to FIG. 4. The node Nⱼ includes a network interface IR that is a radio interface if the node is a mobile terminal, for example, a communication unit UC, a descriptive file management unit UF, and two memories M1 and M2. A dedicated unit US characterizes the node Nⱼ, for example the processor unit of a PC, a server or a mobile terminal. All the entities of the node are connected by a bidirectional communication bus B.

The node Nⱼ communicates with the other nodes of the ad hoc network RA via the network interface IR to send requests and to receive responses to said requests. The communication unit UC composes identification requests RQI sent from the network interface of the node Nⱼ. Similarly, the communication unit UC processes identification responses received by the network interface IR. The descriptive file management unit UF manages the information relating to the node Nⱼ contained in a descriptive file Fⱼ. The management unit UF responds to identification requests RQI relating to the identification of the node Nⱼ sent by other nodes in the ad hoc network. The functions of the units UC, UF and US can be implemented in software modules in the node Nⱼ executed by a central processor unit of the node Nⱼ.

The memory M1 contains, among other things, the descriptive file Fⱼ of the node Nⱼ, a public key KPUⱼ of a public key KPUⱼ/private key KPVⱼ cryptographic pair assigned to the node Nⱼ and a one-way hashing function H. The memory M2 is a secure memory including the private key KPVⱼ of the cryptographic pair.

Referring to FIG. 3, the file Fⱼ of the node Nⱼ is specified by a cryptographic identifier ICⱼ dedicated to the node to set up a link to a more complete description of the node relating to the descriptive parameters Pₗⱼ to Pₘⱼ of the node. In one embodiment of the invention, and in conformance with the Host Identity Protocol (HIP), the cryptographic identifier ICⱼ depends on the public key KPUⱼ of the public key KPUⱼ/private key KPVⱼ cryptographic pair assigned to the node. The cryptographic identifier ICⱼ is the public key KPUⱼ of a hash H(KPUⱼ) of the public key determined by applying the hashing function H to the public key KPUⱼ, the hashed public key H(KPUⱼ) generally being of fixed size and smaller than the public key KPUⱼ.

Node identification based on public keys has the advantage of being universal, each node of the network RA having its own cryptographic pair. Moreover, the cryptographic pair of the node participates in security functions when sending data to a receiving node. Accordingly, signing the data using the private key of the node guarantees the integrity of the data for the receiving node, which verifies the signature using the public key of the node that sent the data. Encrypting the data using the public key of the receiving node guarantees the confidentiality of communication between the node and the receiving node, which alone can decrypt the data using its private key.

The file Fⱼ contains one or more descriptive parameters related to the nature of the node Nⱼ. For example, one descriptive parameter of a personal computer (PC) Nⱼ or N_{J} is its IP address. Similarly, descriptive parameters of the network R include the address of a Dynamic Host Configuration Protocol (DHCP) server or the address of a network gateway such as a HyperText Transfer Protocol (HTTP) proxy. A descriptive parameter of the mobile terminal N₃ or Nⱼ₊₁ is the MSISDN (Mobile Station ISDN (Integrated Services Digital Network)) number of the mobile terminal. The public key KPUⱼ and the hashed public key H(KPUⱼ) of a node are also descriptive parameters contained in the file at each node. All the parameters in the file can be accessed by the other nodes.

Each descriptive parameter Pₘⱼ in the file Fⱼ contains a parameter identifier, such as a name NPₘⱼ and/or a type TPₘⱼ, and a parameter value VPₘⱼ. The name NPₘⱼ is a sub-identifier of the node Nⱼ. The type TPₘⱼ characterizes the parameter Pₘⱼ by indicating, for example, that the parameter is an IPv4 address “A”, an electronic messaging server name “MX” or a text “TXT”. The parameter value VPₘⱼ is requested by another node of the network and is of the form “2001:2:56”, for example, for an address type parameter, or the form “server_name_mail.com” for an electronic messaging server type parameter.

Information other than the descriptive parameters in the file Fⱼ is linked to the descriptive parameter(s) of the file and/or to their name and includes a type and a value. This information corresponds to detection of errors and to the integrity of the information to be sent from the node Nₚ.

An error indication characterized by a type TEₘⱼ and associated with each parameter name NPₘⱼ provides proof of the absence of a value VP of a requested parameter. The error value VEₘⱼ of the error indication contains a list of types linked to a parameter name NPₘⱼ, such as TPₘⱼ, TA, and the name of the next parameter NP₍ₘ₊₁₎ⱼ. Thus an identification request RQI sent by another node relating to a parameter name NPₘⱼ in the file Fⱼ for which the type TPₘⱼ contained in the request is erroneous obtains in response the error value VEₘⱼ. The response indicates that the type contained in this parameter name request does not exist in the file Fⱼ, which is justified by the list of types associated with the name NPₘⱼ of the parameter requested.

Authentication information characterized by a type TA and relating to a respective value VPₘⱼ, VEₘⱼ to be sent to another node that has requested it authenticates the source and guarantees the integrity of said respective value relative to the node Nⱼ. The authentication value VAPₘⱼ, VAEₘⱼ associated with the authentication information corresponds to a signature determined as a function of the respective value VPₘⱼ, VEₘⱼ to be sent and the private key KPVⱼ assigned to the node Nⱼ. For example, the value VAPₘⱼ, VAEₘⱼ is determined by applying the hashing function H to the value VPₘⱼ, VEₘⱼ and by asymmetrical encryption of the hashed value as a function of the private key KPVⱼ assigned to the node. The value VAPₘⱼ sent in a RPI response at the same time as the respective value VPₘⱼ of the requested parameter Pₘⱼ ensures that said respective value comes from the node Nₘⱼ. Similarly, the value VAEₘⱼ sent in a response RPI at the same time as the error value VEₘⱼ relating to the name NPₘⱼ of the requested parameter Pₘⱼ ensures the integrity of the error value VEₘⱼ.

The value VAPₘⱼ, VAEₘⱼ sent is advantageously encrypted by the public key of the other node, thereby guaranteeing the confidentiality of the exchange of information in the response RPI.

To verify the integrity of the value VPₘⱼ, the other node receiving an identification response containing the value VPₘⱼ has also, or previously, requested the public key KPUⱼ associated with the private key KPVⱼ of the cryptographic pair assigned to the node Nⱼ for decrypting the authentication value VAPₘⱼ. The other node then applies the one-way hashing function H to the received value VPₘⱼ to obtain a hashed value and compares the hashed value obtained and the decrypted value, which should be identical.

There are two methods of indexing descriptive parameters in the file Fⱼ.

The first method effects indexing relative to a parameter indexing scheme associating the identifier ICⱼ of the node Nⱼ and the name NPₘⱼ of the parameter to obtain the associated value VPₘⱼ. In this method, the types TPₗⱼ to TPₘⱼ characterizing the parameters Pₗⱼ to Pₘⱼ of the node are identical and do not distinguish between the node parameters. The parameters Pₗⱼ to Pₘⱼ of the node are distinguished by their names NPₗⱼ to NPₘⱼ.

The second method effects indexing relative to a parameter indexing scheme associating the identifier ICⱼ of the node Nⱼ and the type NPₘⱼ of the parameter to obtain the associated value VPₘⱼ. In this method, the types TPₗⱼ to TPₘⱼ characterizing the parameters Pₗⱼ to Pₘⱼ of the node are separate from each other, the parameters not including a name NPₗⱼ to NPₘⱼ. The file Fⱼ then includes an error indication containing all the parameter types and information from the descriptive file of the node Nⱼ, which reduces the size of the file.

Other descriptions are included in the descriptive file to conform to the DNS/DNSSEC specifications. Each descriptive parameter or item of descriptive file information is defined by a class that is exactly the same for all the information, for example the class “IN” relating to the Internet.

The descriptive file contains management information for the file characterized by the type SOA (Start Of Authority), the value of which includes the identity and the address of the file administrator and data describing how the file is managed.

The descriptive file can further include cryptographic information characterized by the type DNSKEY (Domain Name System KEY) relating to the public key of the cryptographic pair assigned to the node.

The values of this additional information are authenticated by authentication information characterized by the type TA.

The identification of a first node N₁ by another node N₂ using the first of the above methods is described below and comprises steps E1 to E8 shown in FIG. 4.

In the step E1, the node N₁ is connected for the first time to the ad hoc network RA. The network interface IR of the node N₁ broadcasts to the other nodes a message MS established by the unit UC of the node N₁ and containing the cryptographic identifier IC₁ of the node N₁ and a source address ADN₁ assigned to the node N₁ in order for the other nodes to identify the node N₁ and send it messages or requests. The address ADN₁ is for example the MAC (Medium Access Control) address of the node including identifiers and a serial number, or alternatively an address formed from the cryptographic identifier IC₁.

In the step E2, the network interface IR of another node N₂ intercepts the message MS. The communication unit UC of the node N₂ establishes an identification request RQI intended for the node N₁ in order to read therein one or more requested descriptive parameters, such as at least the public key assigned to the node N₁, in order to verify the integrity of the parameters coming from the node N₁. In the first method, the request RQI contains at least the identifier IC₁ of the node N₁ extracted from the message MS, the name NPₘₗ of the requested parameter as a parameter identifier, and a source address ADN₂ relating to the node N₂ in order for the node N₁ to send the node N₂ a response to the request RQI.

The node N₂ can request all the parameters of the node N₁ by sending a specific identification request.

In the step E3 the network interface IR of the node N₁ receives the request RQI, which is processed by its communication unit UC. As a function of the cryptographic identifier IC₁ designating the file F₁ and the name NPₘₗ of the requested parameter extracted from the request RQI, the descriptive file management unit UF of the node N₁ looks up the value VPₘₗ and the authentication value VAPₘₗ associated with the parameter name NPₘₗ in the file F₁.

If the values VPₘₗ and VAPₘₗ are found in the file F₁ in the step E4, the communication unit of the node N₁ establishes an identification response RPI including the identifier IC₁ of the node N₁, the name NPₘₗ and the values VPₘₗ and VAPₘₗ of the requested parameter found in the file F₁ of the first node N₁. The response RPI is sent to the node N₂ in the step E5.

In the step E6, the node N₂ receives the response RPI and its communication unit verifies the integrity of the requested parameter value VPₘₗ. The communication unit of the node N₂ decrypts the authentication value VAPₘₗ as a function of the public key KPU₁ assigned to the node N₁ and sent in the response RPI or in an earlier response and produces a decrypted value. The communication unit then applies the one-way hashing function H to the value VPₘₗ extracted from the sent response RPI and compares the hashed value and the decrypted value, which should be exactly the same.

Returning to the step E4, if the values VPₘₗ and VAPₘₗ are not in the file F₁, the control unit UC of the node N₁ establishes an identification response RPI containing the identifier IC₁ of the node N₁, the name NPₘₗ of the parameter, the error value VEₘₗ corresponding to the parameter Pₘₗ, and the associated authentication value VAEₘₗ. In the step E7 the interface IR of the node N₁ sends the response RPI to the node N₂, which verifies the integrity of the error value VAEₘₗ in the step E8 in a manner analogous to the step E6.

In the second indexing method, the identification request RQI and the identification responses RPI do not contain the name NPₘₗ of the parameter, but contain as a parameter identifier the type TPₘₗ characterizing the parameter Pₘₗ. In the steps E3 and E4, values VPₘₗ and VAPₘₗ of the requested parameter Pₘₗ are looked up in the file F₁ as a function of the identifier IC₁ and the parameter type TPₘₗ included in the request RQI sent in the step E2.

If the values VPₘₗ and VAPₘₗ are not found in the file F₁ in the step E4, an error indication containing all the parameter types and information from the descriptive file F₁ and accompanied by the associated authentication value is sent to the node N₂.

As shown in FIGS. 5 to 8, identification request RQI frames and identification response RPI frames of the invention have identical field structures and conform to the frames of the DNS/DNSSEC specification.

A frame includes at least four fields. A first or header field C_ET indicates if the frame relates to an RQI request or to an RPI response, a second field C_RQ contains the request, a third field C_RP contains the response, and a fourth field C_AD can contain additional information.

According to the first indexing method, and referring here to FIGS. 5 and 6, the field C_RQ of the request RQI and of the response RPI includes the name NPₘⱼ of the requested parameter associated with the identifier ICⱼ of the node Nⱼ for which the request is intended. The parameter type TPₘⱼ is included in the request in order to conform to the DNS/DNSSEC specification but does not distinguish between parameters.

The field C_RP of the response RPI also includes the name NPₘⱼ of the requested parameter associated with the identifier ICⱼ and the type TPⱼ of the parameter and further includes the value VPₘⱼ of the parameter and the associated authentication value VAPₘⱼ.

According to the second indexing method, and referring here to FIGS. 7 and 8, the field C_RQ of the request RQI and of the response RPI includes the identifier ICⱼ of the node Nⱼ for which the request is intended and the type TPₘⱼ characterizing the requested parameter.

The field C_RP of the response RPI also includes the identifier ICⱼ and the type TPₘⱼ of the parameter and further includes the value VPₘⱼ of the parameter and the associated authentication value VAPₘⱼ.

The additional field C_AD of the identification response RPI of a node Nⱼ can contain parameters useful for a first exchange with another node, such as the public key KPUⱼ or the IP address of the node Nⱼ.

The invention is not limited to ad hoc networks with no infrastructure, and can equally be implemented in a network with an infrastructure such as the Internet in which the nodes have access to the DNS. In this situation, the identification system of the invention is easy to integrate into the DNS without introducing any ambiguity. The DNS/DNSSEC databases relating to the invention associate with a domain name of a node Nⱼ an address IPⱼ and a cryptographic identifier ICⱼ.

Thus a client node can obtain the cryptographic identifier ICⱼ of the node Nⱼ by means other than receiving said identifier broadcast by the node Nⱼ.

To obtain the cryptographic identifier of a node Nⱼ, the client node requests the identifier ICⱼ associated with the domain name of the node Nⱼ from one of the DNS servers connected to a database that sends it to it. The client node obtains a more detailed description of the node Nⱼ after the steps E2 to E8 of FIG. 4.

Alternatively, a client node that requests the IP address of the node Nⱼ from a DNS server also obtains in response the cryptographic identifier ICⱼ of the node Nⱼ included in the additional field C_AD.

The invention described here relates to a method and to heterogeneous nodes. In one embodiment, the steps of the method of the invention are determined by the instructions of a computer program incorporated in the node. The program includes program instructions which, when said program is executed in a processor of the node, the operation of which is then controlled by the execution of the program, execute the steps of the method of the invention.

Consequently, the invention applies equally to a computer program, in particular a computer program on or in an information medium, adapted to implement the invention. That program can use any programming language and take the form of source code, object code, or an intermediate code between source code and object code, such as a partially-compiled form, or any other form that is desirable for implementing the method of the invention.

The information medium can be any entity or device capable of storing the program. For example, the medium can include storage means, such as a ROM, for example a CD ROM or a microelectronic circuit ROM, or a USB key, or magnetic storage means, for example a diskette (floppy disk) or a hard disk.

Moreover, the information medium can be a transmissible medium such as an electrical or optical signal, which can be routed via an electrical or optical cable, by radio or by other means. The program of the invention can in particular be downloaded over an Internet-type network.

Alternatively, the information medium can be an integrated circuit into which the program is incorporated, the circuit being adapted to execute the method of the invention or to be used in its execution.

1. A method of identifying a node to other nodes in a communications network, wherein it comprises the following steps:
storing in each node a file containing descriptive parameters of the node, each parameter being indexed by a cryptographic identifier of the node and a parameter identifier;
a first node, on connecting to the network, broadcasting to the other nodes of the network the cryptographic identifier of said first node;
sending the cryptographic identifier of the first node and the identifier of a parameter of the first node requested by another node of the network from said other node to the first node;
searching for a portion of the requested parameter in the file of the first node as a function of the cryptographic identifier and the identifier of the requested parameter; and
sending the found portion of the requested parameter from the first node to said other node.

2. A method according to claim 1, wherein the parameter identifier is a name dedicated to the parameter.

3. A method according to claim 1, wherein the parameter identifier is a type characterizing the parameter.

4. A method according to claim 1, wherein the cryptographic identifier of a node depends on a public key of a public key/private key pair assigned to the node.

5. A method according to claim 4, wherein the parameter portion is sent with a signature of said parameter portion determined by the private key assigned to the first node.

6. A method according to claim 1, including, if the file of the first node does not contain the requested parameter part, sending an error indication contained in the file and proving absence of said portion of the requested parameter in the file.

7. A method according to claim 1, wherein the communications network is an ad hoc network.

8. A node of a communications network, wherein it comprises:
a memory for a file containing descriptive parameters of the node, each parameter being indexed by a cryptographic identifier of the node and a parameter identifier;
means for broadcasting the cryptographic identifier of said node to the other nodes of the network;
means for sending the cryptographic identifier of a first other node and the identifier of a parameter of said first other node requested by said node;
means for searching the file for a portion of a parameter requested by a second other node as a function of the cryptographic identifier of said node and the identifier of the parameter sent by the second other node; and
means for sending to said second other node the found portion of the parameter requested by said second other node.

9. A computer program adapted to be executed in a node of a communications network, wherein it comprises instructions which, when the program is executed in said node, execute the following steps:
storing in the node a file containing descriptive parameters of the node, each parameter being indexed by a cryptographic identifier of the node and a parameter identifier;
broadcasting the cryptographic identifier of said node to the other nodes of the network;
sending the cryptographic identifier of a first other node and the identifier of a parameter of said first other node requested by said node;
searching for a portion of a parameter requested by a second other node in the file of said node as a function of the cryptographic identifier of said node and the identifier of the parameter sent by the second other node; and
sending the found portion of the parameter requested by the second other node to said second other node.

10. Partially or totally removable data storage means containing computer program code instructions for executing the steps of a method according to claim 1.
